(19) United States
(12) Patent Application Publication
(10) Pub. No.: US 2014/0144307 A1
(43) Pub. Date: May 29, 2014

(54) GUITAR

(71) Applicant: Juan José Hugo Ceja Estrada, Sinaloa (MX)

(72) Inventor: Juan José Hugo Ceja Estrada, Sinaloa (MX)

(21) Appl. No.: 14/114,869

(22) PCT Filed: May 4, 2011
(86) PCT No.: PCT/MX2011/000052

§ 371 Date: Feb. 11, 2014

(51) Int. Cl. G10D 3/02; G10D 3/04

(52) U.S. Cl. CPC G10D 3/02; G10D 3/04
USPC 84/294

(57) ABSTRACT

Guitar or other string instrument that includes a bridge located between the strings and the resonating surface, which has the advantage of being fixed to the front of the guitar by means of securing means placed at the ends of said bridge, which improves the durability of the bridge, without it detaching from the guitar despite use, and holds the strings at a suitable height above the fingerboard of the instrument.

REFERENCE TO RELATED APPLICATIONS

This is US National Phase of PCT/MX2011/000052 filed May 4, 2011.

### FIELD OF THE INVENTION

The present invention relates to an improvement to a guitar or other stringed instrument in the part which houses the bridge which holds the strings and transmits the vibration to the instrument case.

### BACKGROUND OF THE INVENTION

As is known, classical guitars are made from a sounding, hollow front hole on establishing a set of six strings running through the mast, which can be stretched at will by pin operatively arranged in the end of said mast, complementing this set with a plurality of frets, bone or metal, disposed transversely to the mast with a progressively increasing distance from the casing to the free end of said mast.

The bridge of a guitar or other stringed instrument, is a part that holds the strings and transmits the vibration to some other structural component of the instrument in order to transfer the sound to the air.

Most string instruments produce sound by applying energy to the strings to bring them into vibratory motion. But the strings by themselves, produce sound by vibrating weak because only a very small volume moving air. Therefore, it is necessary that the sound of the strings have any impedance matching with the surrounding air to transmit its vibrations to a larger surface area capable of moving large volumes of air (and thus produce louder sounds). The device used for this is the bridge that allows free vibrating strings, yet these vibrations efficiently leads to greater surface area (usually called soundboard).

Typically, the bridge is placed perpendicular to the strings and the larger surface area (which are approximately parallel to each other) with the string tension pressing on the bridge and therefore the surface of largest area under the bridge. This large surface area has increased acoustic response and may be coupled to a soundboard which is a box-like body of the guitar or the violin, which helps amplify the sound. Depending on the type of string instrument, the resonant surface on which sits the bridge can be built of wood, and the top cover (harmonic) of a guitar or violin calfskin or plastic, such as the banjo, of metal, such as certain types resophonic fretted instruments, or any other material to vibrate in a coupled manner with the strings.

The bridge must transfer the vibration to the soundboard or other surface amplifier. When the strings are set in motion, the bridge transmits the vibration to flex in one direction and the other in the direction of the rope, at a frequency which Is twice the vibration frequency of the string. This makes the soundboard at the same frequency to vibrate the string producing a movement and an audible sound wave.

Bridges are designed to keep the strings at a suitable height above the instrument dispason or fingerboard. The ideal height of the bridge is one that generates a rope angle such that it produces sufficient downward force to move the lid, hut which in turn the ropes located sufficiently close to the fork to facilitate the crushing of the strings. There are bridges and other fixed height adjustable height.

Besides supporting the strings and transmit their vibrations, the bridge also controls the spacing between the strings. This is achieved through small slits cut into the bridge or saddle. The strings are recorded in these slots and thus are retained in their lateral position.

The present invention provides a solution to a typical problem in classical guitars and other stringed instruments, where the bridge tends to rise with use.

Spanish Patent ES 1 007 643 U discloses a guitar equipped with means to prevent direct contact between the body and the person playing the instrument case, so that the problem does not occur loudness reduction of traditional guitars. Guitar addition the invention is characterized in that it has on the outside of the box rear panel sections and three side walls all made of wood. Although the above invention relates to the improvement of a more specific guitar called a Spanish guitar does not tackle the problems that are usually present on the bridge.

Spanish patent ES 1012513 U refers to an enhanced capo for guitars and the like where the inventor has designed a new system built wood nut that fits the criteria of the players, however, it does not refer to an improvement in the problems encountered in the mast.

Spanish Patent ES 297113 refers to a series of improvements in the structuring of guitars, which are oriented towards obtaining a substantial improvement in the sound of them. In particular the invention says that at the mercy of the nature of the strings from the “thinner string which produces a brighter sound to the thicker string which produces a deeper sound, and by the effective shortening of any of such strings, by manual pressure on them in the space defined between two consecutive frets, you get a wide range of tones that gives the guitar its functionality as such musical element. However, said patent does not address the problems that arise in the bridge, which when the position changes, the sound quality will be lost.

The present invention significantly improves the functioning of a guitar, in particular, we solve the old problem that represents the shedding of the bridge with the use or poor quality adhesive materials.

The invention provides a simple, strength, deformability, aesthetics, perfect adaptation and economy.

The object of the present invention to provide an alternative to the stringed instruments, especially guitars, with the proposal of using fasteners to the bridge, and the glue that has traditionally been used by manufacturers of such instruments.

The above-mentioned clamping means can be of various types, namely screws or rivets, stainless materials are preferably proposed which could be hidden in the material forming the bridge.

Generally, the section of material forming the bridge can be a type of wood and the shape can be rectangular, such as those conforming the conventional guitars. The proposal of the present invention is to place the screws on both sides of the rectangle that forms the improved bridge, holding it from the front cover of the instrument, and using means to clamp without damaging the constituent material of the top or soundboard of the instrument.

### OBJECT OF THE INVENTION

The present invention relates to an improvement to a guitar or other stringed instrument in the part which houses the bridge which holds the strings and transmits the vibration to the instrument case.

### BRIEF DESCRIPTION OF THE INVENTION FIGURES

To complement the description being made and in order to aid a better understanding of the characteristic of the invention, attached to this specification as an integral part thereof, the drawings in an illustrative and non-limiting is represented as follows:

FIG. 1.—Shows a plan view of a guitar constructed in accordance with the present invention.

FIG. 2.—It shows a rear plan view of a guitar constructed in accordance with the present invention.

FIG. 3.—Shows guitar section corresponding to an anterior plan view of the bridge.

FIG. 4.—Shows guitar section corresponding to a rear plan view of the bridge.

FIG. 5.—Is a perspective view of a guitar constructed in accordance with the invention.

FIG. 6.—Is a horizontal sectional view showing how to fix the bridge with screws “shovel”.

FIG. 7.—Is a horizontal sectional view showing how to fix the bridge with screws “cross”.

FIG. 8.—Is a horizontal sectional view showing the manner of fixing the bridge with rivets.

FIG. 9.—Shows a plan view of the bridge fastened with screws “cross” in the front cover of the guitar.

FIG. 10.—Shows a plan view of the bridge fixed with screws to “shovel” the front cover of the guitar.

FIG. 11.—Shows a plan view of the bridge fast led with screws “rivets” to the front cover of the guitar.

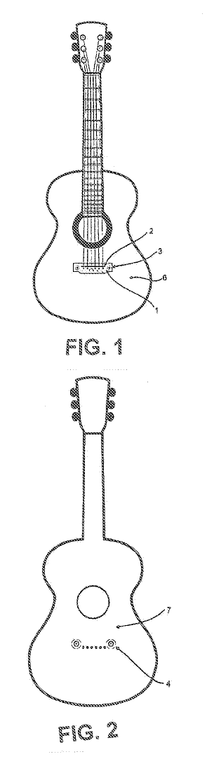

### DETAILED DESCRIPTION OF THE INVENTION

With reference to the accompanying figures, the bridge (1) can comprise several parts. In general, it has a supporting surface called mount (2) on which the strings are supported. This usually is a harder material than that of the bridge, such as bone, ivory, plastic or metal. Said bridge (1) can be fixed to the front cover with external view (6) of the guitar, by means (3), which may be screws or rivets. Preferably, Allen screws (3) with nut (4) and washer (5) can be used. Alternatively, these screws may be “shovel” (8) “cross” (9) or rivets (10).

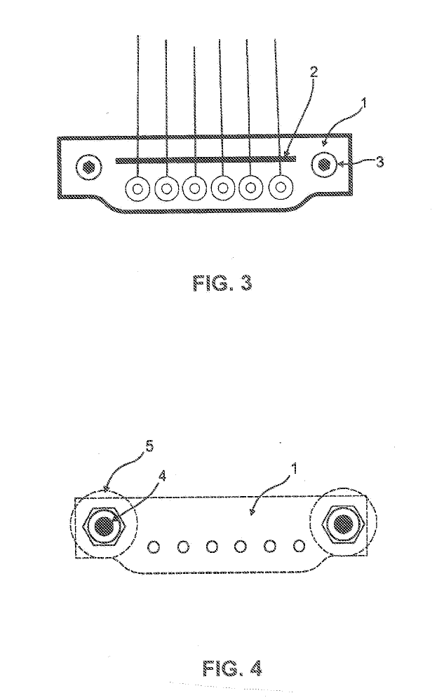

FIG. 3 shows the position of the screws (3) in the bridge (1), preferably placed at the ends of said bridge (1).

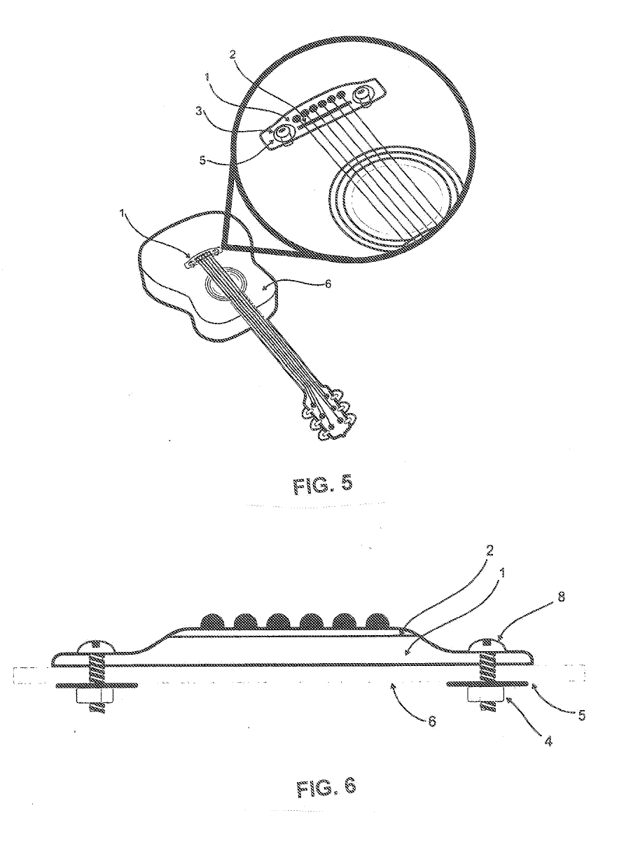

FIG. 6 shows a sectional view of the bridge (1) bolted to the front cover (6) of the guitar. As shown in the figure, the flat washer (5) distributes pressure nut (4) on the timber of the front cover (6) of the guitar.

As the bridge is usually subjected to vibration, the present invention contemplates that the bridge must be screwed to the cover (6) in harmony with the glue used by the manufacturer. The presence of screws prevents potential failures glue, usually taking chips off the wood that forms the top of a guitar or other stringed instrument.

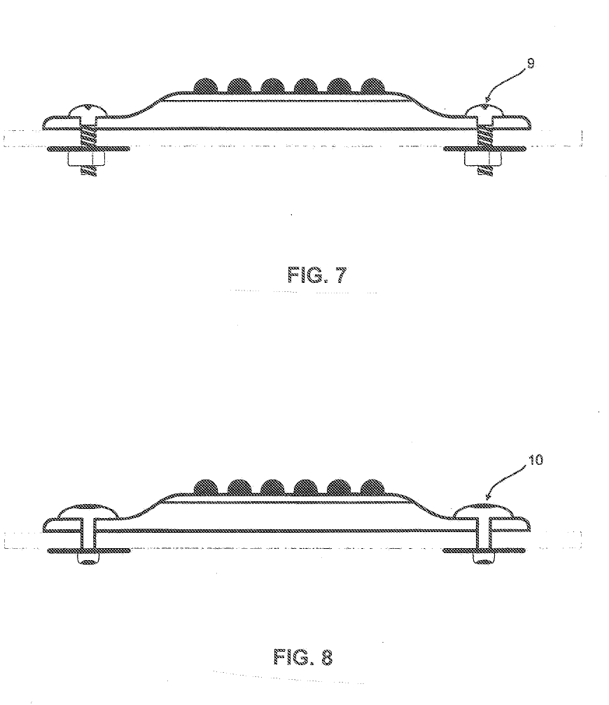

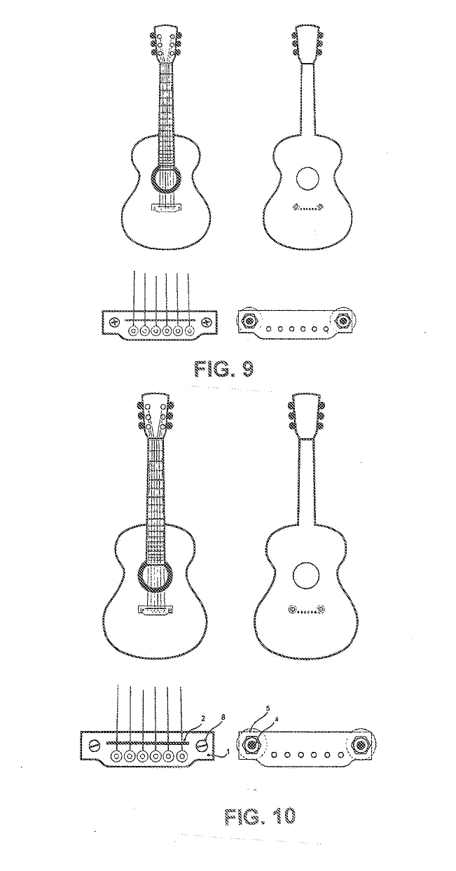

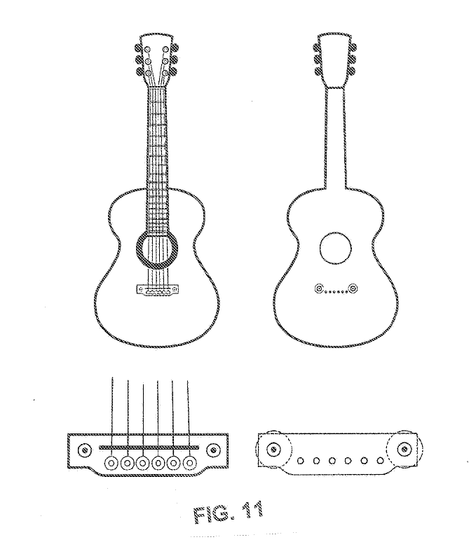

FIGS. 6 to 8 show the screws or rivets placed in a position that does not affect the functioning of the frame (2) as support for the strings. Said screws or rivets, alternatively may be hidden within the material forming the bridge.

The intensity and quality of the sound of a guitar or other stringed instrument depends mainly on the characteristics of the case, such as construction type or system thereof, type of wood used, etc. It is also important to note that if abridge is located in the appropriately facilitate intonation and loudness regulation and avoiding discomfort mainly guitarist or other musician of strings in some chords, especially in the execution of topics stylists.

The present invention is given not in any known stringed instrument and this is an interesting innovation, because it's adaptation of the fastening means are placed in perfect coincidence geometric, allowing no risk of alteration in the intensity and quality of musical instrument sound.

Having sufficiently described my invention, I think as a novelty and the claim both as my sole property, the matter contained in the following:

1. A stringed instrument comprising:
a bridge located between a plurality of the strings and a resonant surface,
wherein said bridge is attached to a front cover of the stringed instrument by fastening devices placed on ends of said bridge.

2. The stringed instrument according to claim 1, wherein said fastening devices are allen screws rivets, and a washer;
wherein the fastening device distributes the pressure of a nut on a timber of the front cover of the stringed instrument.

3. The stringed instrument according to claim 1, wherein the stringed instrument is a guitar.

4. The stringed instrument according to claim 1, wherein the bridge is made of wood or fiber.

5. The stringed instrument according to claim 1, wherein the stringed is made of wood.
